(19) United States
(12) Patent Application Publication
(10) Pub. No.: US 2021/0235890 A1
(43) Pub. Date: Aug. 5, 2021

(54) FOOD SHIELD END PANEL AND CLIP SYSTEM

(71) Applicant: Brass Smith Innovations, LLC (BSI Designs), Wilmington, DE (US)

(72) Inventors: Geoffrey R. Quinter, Denver, CO (US); Wayne Sirmons, Denver, CO (US)

(21) Appl. No.: 16/781,806

(22) Filed: Feb. 4, 2020

(51) Int. Cl. A47F 10/06; F16B 5/06

(52) U.S. Cl. CPC A47F 10/06; A47F 2010/065; F16B 5/0685

(57) ABSTRACT

A reconfigurable multiple-piece end panel and mounting system for a food shield and a food shield system and methods. In some embodiments, the food shield system includes a support stand, a customer-facing panel supported by the support stand, and an end panel having a rear portion and a physically separate front portion that is independently removable from the end panel without the use of tools. The end panel mounting system provides for the front portion of the end panel to be selectively mounted to the support stand in a forward configuration where the front portion fully covers the adjacent outside edge of the customer-facing panel, or mounted in a reversed configuration where the front portion does not fully cover the adjacent outside edge of the customer-facing panel.

### RELATED APPLICATIONS

This application claims priority to U.S. Patent Application Ser. No. 62/801,533 (the '533 application), filed on Feb. 5, 2019 by Geoffrey R. Quinter et al. (attorney docket no. 0702.09PR), entitled, “FOOD SHIELD END PANEL AND CLIP SYSTEM”, the entire teachings of which are incorporated herein by reference in its entirety for all purposes.

### FIELD OF THE INVENTION

The present disclosure relates to systems, apparatus and methods for implementing a food shield, and more particularly to systems, apparatus and methods for implementing a food shield with a reconfigurable multiple-piece end panel.

### BACKGROUND OF THE INVENTION

Food shields, also sometimes called sneeze guards, are used in a variety of settings. Typically, a food shield includes at least one transparent panel that is suspended over a buffet, smorgasbord, salad bar, retail display, or other kind of food display. The food shield serves to attractively display the food while protecting the food from falling debris or other contamination. A typical food shield also includes end panels to protect the food from the side. An end panel is typically fabricated from a transparent material such as glass or transparent acrylic.

NSF International (NSF) regulations require the end panels of a food shield to fully cover the outside edge of any customer-facing panels throughout their entire range of motion. This results in an end panel that is large and has a bullnose shape extending toward the customer, making cleaning and routine maintenance of interior food shield structures and surfaces more difficult. Furthermore, conventional systems often use a single bolt or screw through the end panel material and the adjacent tubular superstructure to attach the end panel glass to the system. This style of mounting makes disassembly of an end panel for maintenance or cleaning difficult without impacting the overall alignment of the system.

The embodiments disclosed herein are directed toward overcoming one or more of the above problems.

### SUMMARY

Various embodiments disclosed herein provide improved apparatus and methods for implementing a food shield. Certain disclosed embodiments provide apparatus for implementing a food shield with a reconfigurable multiple-piece end panel and a mounting system that provides for the end panel to be attached, removed and reconfigured without the use of tools. One representative example is a food shield system including a support stand, a customer-facing panel supported by the support stand, and an end panel having a rear portion and a physically separate front portion that is independently removable from the end panel.

The food shield system also includes a mounting system attached to the support stand. In some embodiments, the mounting system provides for the rear portion of the end panel and the front portion of the end panel to be independently mounted to and removed from the support stand without the use of tools. The mounting system can remain attached to the support stand when one or both the front portion and the rear portion of the end panel are removed from the system.

In addition, the mounting system can provide for the front portion of the end panel to be selectively mounted to the support stand in a forward configuration where the front portion fully covers the adjacent outside edge of the customer-facing panel, or mounted in a reversed configuration where the front portion does not fully cover the adjacent outside edge of the customer-facing panel. The reversed configuration is particularly useful for storage, and can be implemented during use, while remaining within NSF compliance, if the customer-facing panel is pivoted to a vertical orientation.

A representative mounting system includes one or several clips operatively associated with a stand pole of the support stand and a thumb screw in threaded engagement with the clip such that the head of the thumb screw extends to the outside of the end panel away from the support stand. Thus, the thumbscrew may be operated from outside the end panel and removed, to permit removal of the front portion and/or rear portion of the end panel without the use of tools, while the clip remains attached to the support stand. One disclosed clip embodiment includes a first clip half, a second clip half, and a clip screw configured to draw the first clip half and the second clip half together around the stand pole.

The clips may be configured the hold one or both portions of the end panel. For example, a first clip may have a glass bushing extending from the first clip half through a hole in just one of front portion or the rear portion of the end panel plus a threaded socket in the glass bushing configured to receive the thumb screw. Another clip may have a glass bushing having an extended length to pass through and support both the front portion and the rear portion of the end panel at a point where the front portion and the rear portion overlap. A clip with an extended length bushing will also include a threaded socket configured to receive a thumbscrew.

Alternative embodiments include a separate end panel and clip assembly as described above or methods of providing and configuring a food shield end panel.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

FIG. 1 is a perspective view of a food shield system with reconfigurable end panels as disclosed herein.

FIG. 2 PRIOR ART, is a side elevation view of a conventional one-piece end panel.

FIG. 3A is a perspective view of an end panel clip and thumbscrew as disclosed herein.

FIG. 3B is an exploded perspective view of the end panel clip and thumbscrew of FIG. 3A.

FIG. 4 is a perspective view of the food shield system of FIG. 1 with the front portion of the end panel in a reversed configuration.

FIG. 5 is a side elevation view of the food shield system of FIG. 1 with the front portion of the end panel in a forward configuration.

FIG. 6 is a plan view of the food shield system of FIG. 1 with the front portion of the end panel in a forward configuration.

FIG. 7 is a side elevation view of the food shield system of FIG. 1 with the front portion of the end panel in a reversed configuration.

FIG. 8 is a plan view of the food shield system of FIG. 1 with the front portion of the end panel in a reversed configuration.

FIG. 9 is an exploded perspective view of an end panel and end panel and clip system as disclosed herein.

FIG. 10A is a perspective view of the end panel and clip system of FIG. 9 with the front portion of the end panel attached in a forward configuration.

FIG. 10B is a perspective view of the end panel and clip system of FIG. 9 with the front portion of the end panel attached in a reversed configuration.

### DETAILED DESCRIPTION OF THE INVENTION

In the following description, for the purposes of explanation, numerous specific details are set forth in order to provide a thorough understanding of the described embodiments. It will be apparent to one skilled in the art, however, that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

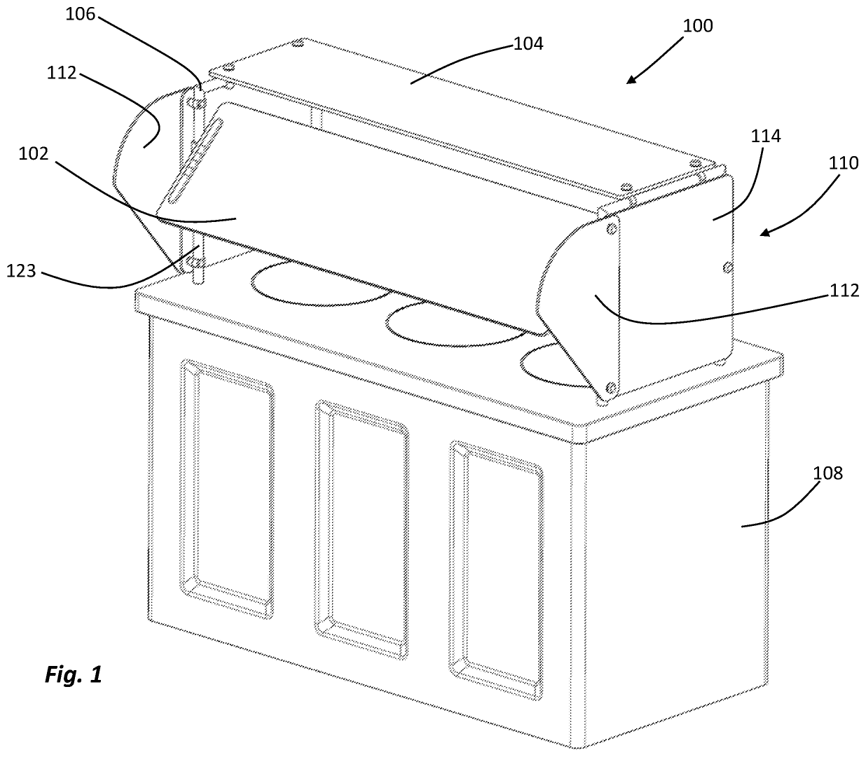

FIG. 1 shows a perspective views of one example of a food shield system 100 having a customer-facing panel 102 and top 104 supported by a stand 106 over a base 108. The system 100 also includes two end panels 110 attached to the outside of the stand 106.

The base 108 may be generally configured as a cabinet, table, bar, counter, or the like. The base 108 may include various configurations of trays, receptacles, openings, heating elements, cooling elements, or similar apparatus to permit the attractive and sanitary display of food items. The food shield system 100 may be used in a variety of settings, for example at a buffet, smorgasbord, salad bar, other kind of food display, other retail display, or the like. The food shield system 100 may be as large or complicated as required and can include multiple bases 108, multiple panels 102, 104, 110 and multiple stands 106 in any configuration. In use, the food shield system 100 protects food or other merchandise from falling debris or other contamination. The panels 102, 104, 110 are therefore typically clear or transparent to enable customers to view displayed food or other products. Representative panels 102, 104, 110 might be fabricated from glass, transparent acrylic, transparent polycarbonate, or similar materials.

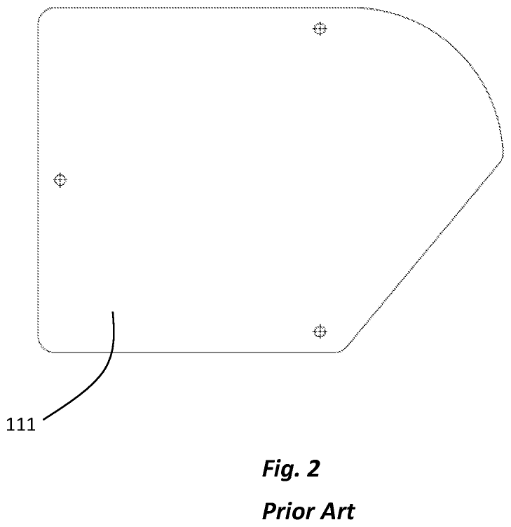

The customer-facing panel 102 can be attached with brackets permitting this panel to be selectively pivoted from a more horizontal to a more vertical orientation. NSF regulations require that the end panels 110 fully cover the outside edge of the customer-facing panels 102, throughout the entire possible range of motion of the customer-facing panels 102. This requirement has resulted in relatively large bull nosed end panels 111 having the shape generally shown in FIG. 2. Conventional end panels are typically implemented as a single large sheet of glass or another transparent material.

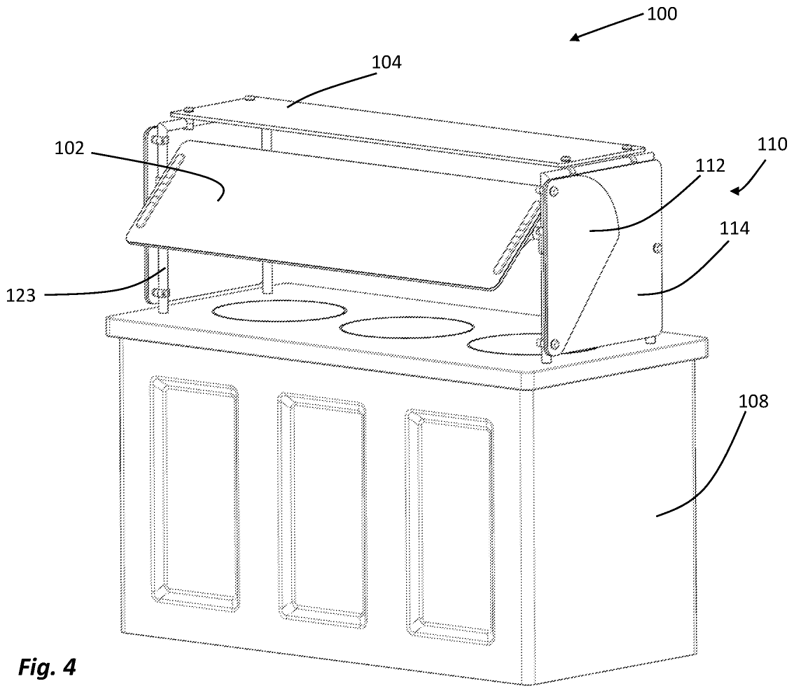

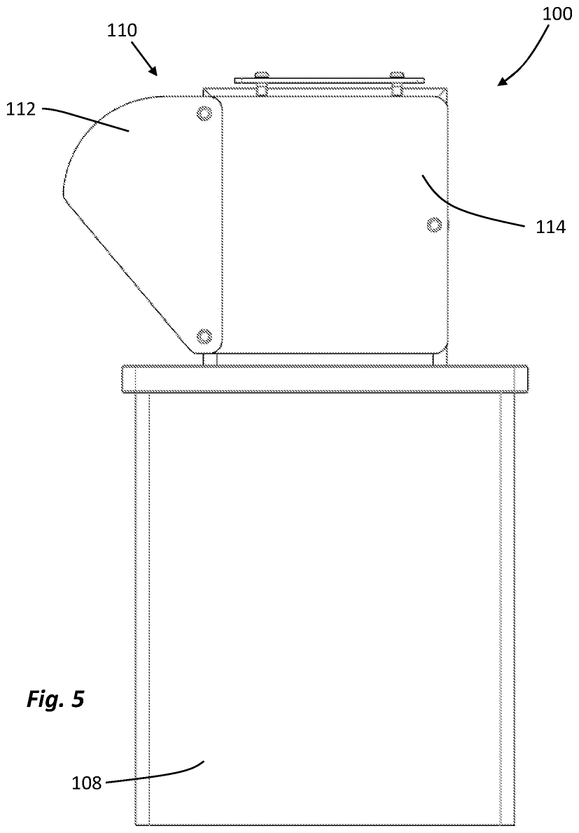

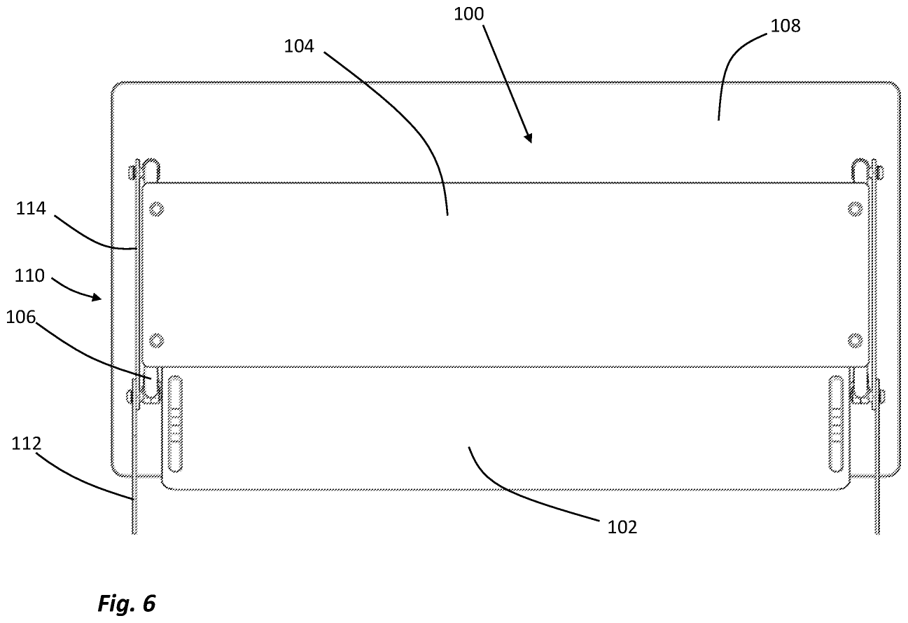

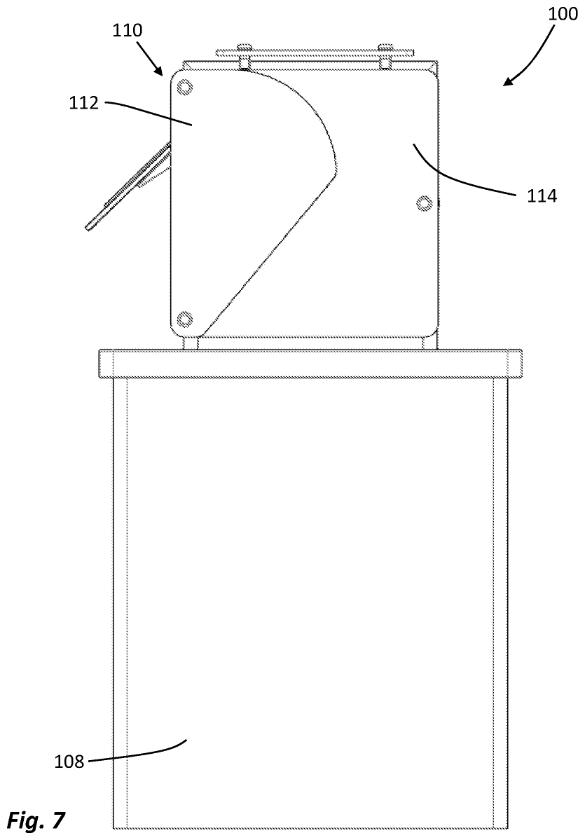

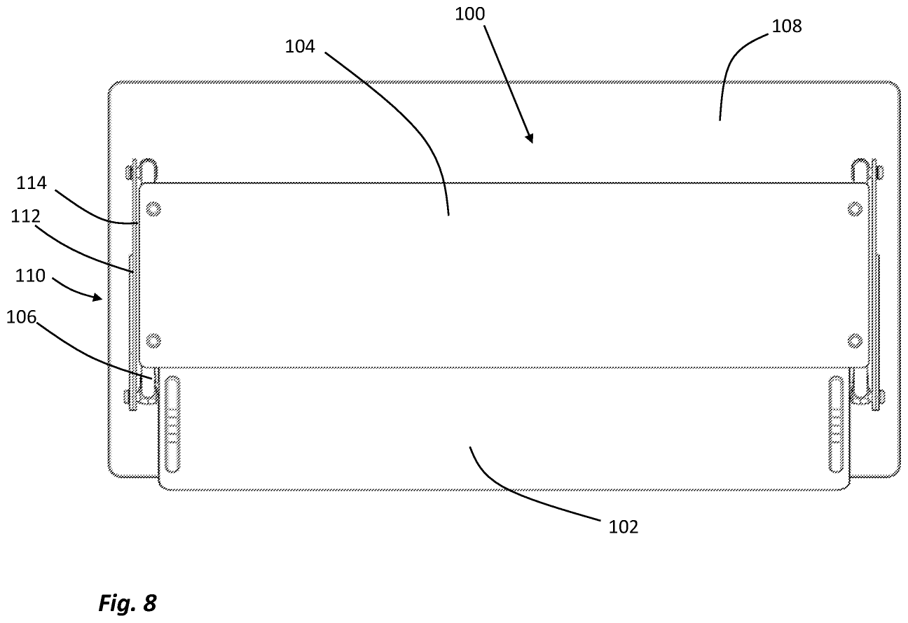

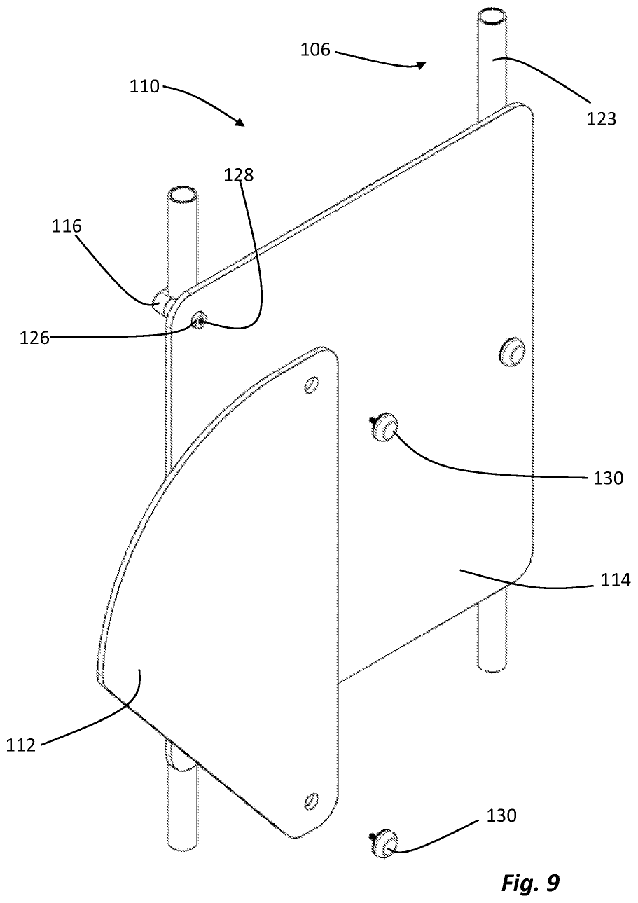

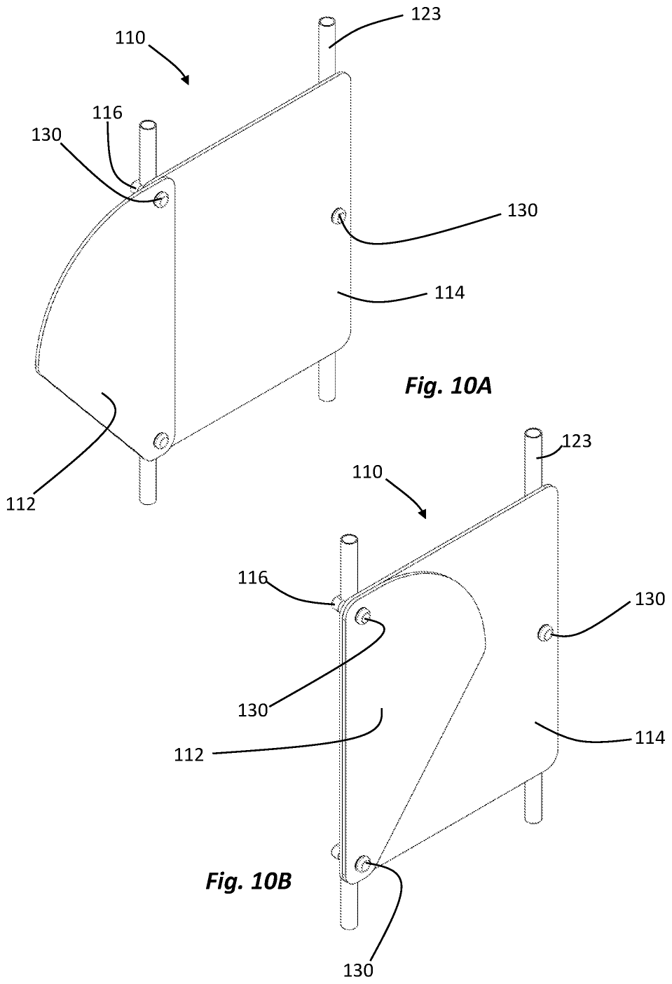

Returning to FIG. 1. the embodiments disclosed herein include an end panel 110 fabricated from multiple subpanels. For example, a representative end panel 110 may include a front portion 112 and the rear portion 114 as illustrated in FIG. 1, and FIGS. 4-9. Separating the end panel into two portions 112 and 114 permits a user to remove the front portion 112 to more readily access interior portions of the system 100 for maintenance or cleaning. Alternatively, the front portion 112 may be mounted in a reversed fashion as shown in FIGS. 2, 5, 6, and 9 to eliminate the bullnose extension. The reversed configuration is particularly useful for storage, and can be implemented during use, while remaining within NSF compliance, if the customer-facing panel 102 is pivoted to a vertical orientation.

Known monolithic end panels, such as that illustrated in FIG. 2, are typically mounted to a stand 106 with bolts or screws. Typically, each bolt or screw extends through a hole in the end panel material and a corresponding hole in the stand 106. Therefore, removing a conventional end panel while maintaining the overall alignment of the stand can be difficult. The embodiments disclosed herein include separate end panel clips 116 that may be mounted to a post with a devoted screw while the end panel glass is attached to the clip 116 with a separate thumbscrew. Thus, the front portion 112, the rear portion 114 or both portions of the disclosed end panel 110 may be removed from the stand 106 without removing the end panel clips 116, and without the use of tools.

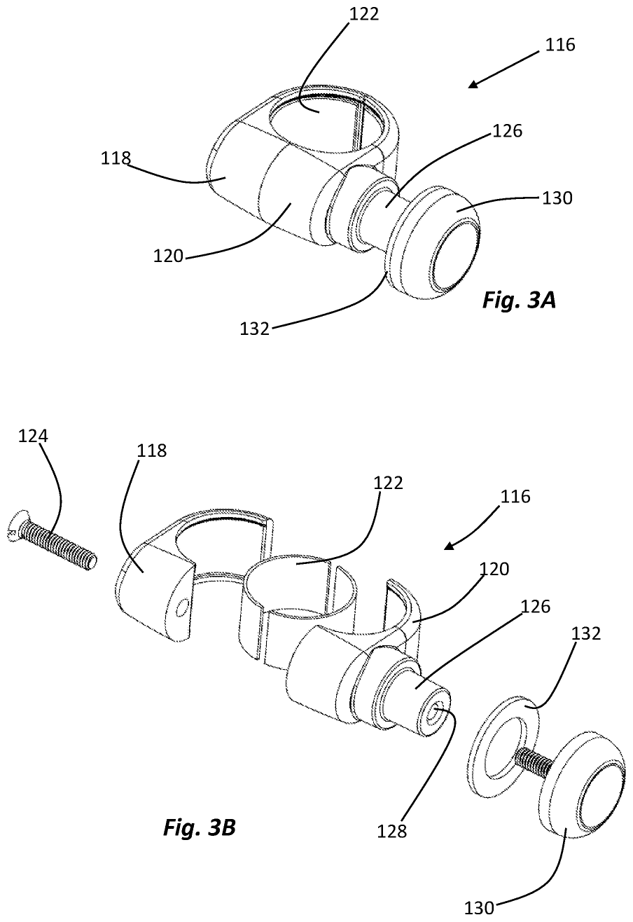

Specifically, as shown in FIGS. 3A and 3B, an end panel clip 116 may include first and second clip halves 118 and 120 respectively. The clip halves 118, 120 define an opening surrounding an optional sleeve 122 configured to provide friction between the clip halves 118, 120 and a stand pole 123. The opening may be round, square, or have another shape depending on the cross-section of the associated pole. The clip 116 may be securely mounted to a pole by drawing the clip halves 118, 120 together with the clip screw 124.

The outside clip half 120 includes, or is mounted to, an extension having a glass bushing 126. The glass bushing includes a threaded opening 128 configured to receive the threaded portion of thumbscrew 130. In use, a hole formed through an end panel portion 112, 114 is placed over the glass bushing 126 and is held securely by a washer 132 and the thumbscrew on the outside of the end panel portion 112, 114. The length of the glass bushing 126 may be formed to accept one end panel portion, or both end panel portions.

The foregoing configuration permits the removal of one or more end panel portions 112, 114 from the stand 106 utilizing thumbscrews 130, and therefore without the use of tools. Furthermore, the end panel clips 116 can remain attached to the stand when one or more end panels are removed. In certain instances, it may be desirable to selectively remove a front end panel portion 112 and remount it to the stand 106 in a reversed configuration as shown in FIGS. 4, 7, 8, and 9B. This configuration may be desired, for example during temporary storage, or when a system 100 is closed for the evening. Operation of the thumbscrews 130 provides a user with an easy, rapid, and tool free method of returning the front and panel portion 112 to the forward configuration of FIGS. 1, 5, 6, and 9A.

Having described certain exemplary embodiments, it will be understood by those skilled in the art that many changes in construction and widely differing embodiments and applications of the invention will suggest themselves without departing from the scope of the present invention. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise.

What is claimed is:

1. A food shield system comprising:
a support stand;
a customer-facing panel supported by the support stand; and
an end panel supported by the support stand, wherein the end panel comprises a rear portion and a separate front portion that is independently removable from the end panel.

2. The food shield system of claim 1 further comprising a mounting system attached to the support stand, wherein said mounting system provides for the rear portion of the end panel and the front portion of the end panel to be mounted to and removed from the support stand without the use of tools.

3. The food shield system of claim 2 wherein the mounting system remains attached to the support stand when one or both of the front portion and the rear portion of the end panel are removed from the system.

4. The food shield system of claim 2 wherein the mounting system provides for the front portion of the end panel to be selectively mounted to the support stand in a forward configuration where the front portion fully covers an adjacent outside edge of the customer-facing panel, and in a reversed configuration where the front portion does not fully cover the adjacent outside edge of the customer-facing panel.

5. The food shield system of claim 2 wherein the mounting system comprises:
a clip operatively associated with a stand pole of the support stand; and
a thumb screw in threaded engagement with the clip such that a head of the thumb screw extends to the outside of the end panel away from the support stand.

6. The food shield system of claim 5 wherein the mounting system further comprises:
a first clip half;
a second clip half; and
a clip screw configured to draw the first clip half and the second clip half together around the stand pole.

7. The food shield system of claim 6 wherein the mounting system further comprises:
a glass bushing extending from the first clip half through a hole in at least one of the front portion and the rear portion of the end panel; and
a threaded socket in the glass bushing configured to receive the thumb screw.

8. The food shield system of claim 7 wherein the mounting system further comprises:
a second clip having a second glass bushing having a second length selected to extend through both the front portion and the rear portion of the end panel at a point where the front portion and the rear portion overlap;
a threaded socket in the second glass bushing configured to receive a second thumbscrew; and
a second thumbscrew.

9. An end panel system for a food shield comprising:
a rear portion;
a physically separate front portion;
at least one clip configured to mount to a support stand; and
a thumb screw in threaded engagement with the clip such that a head of the thumb screw extends to the outside of the rear portion or the front portion to secure the end panel to the clip.

10. The end panel system of claim 9 wherein the clip comprises:
a first clip half;
a second clip half; and
a clip screw configured to draw the first clip half and the second clip half together.

11. The end panel system of claim 10 wherein the clip further comprises:
a first glass bushing extending from the first clip half through a hole in at least one of the front portion and the rear portion of the end panel; and
a threaded socket in the first glass bushing configured to receive the thumb screw.

12. The end panel system of claim 11 further comprising:
a second clip having a second glass bushing having a second length selected to extend through both the front portion and the rear portion of the end panel at a point where the front portion and the rear portion overlap;
a threaded socket in the second glass bushing configured to receive a second thumbscrew; and
a second thumbscrew.

13. A method of providing an end panel for a food shield system comprising:
providing a support stand;
attaching a customer-facing panel to the support stand; and
attaching an end panel to the support stand, wherein the end panel comprises a rear portion and a physically separate and independently removable front portion.

14. The method of claim 13 further comprising:
attaching a mounting system to the support stand;
mounting the rear portion of the end panel without the use of tools;
mounting the front portion of the end panel to the mounting system without the use of tools; and
removing the front portion of the end panel from the mounting system without the use of tools.

15. The method of claim 14 further comprising keeping the mounting system attached to the support stand when the front portion of the end panel is removed from the system.

16. The method of claim 14 further comprising:
mounting the front portion of the end panel to mounting system in a forward configuration where the front portion fully covers an adjacent outside edge of the customer-facing panel; and
mounting the front portion of the end panel to the mounting system in a reversed configuration where the front portion does not fully cover the adjacent outside edge of the customer-facing panel.

17. The method of claim 14 further comprising:
attaching a clip to a stand pole of the support stand; and
engaging a thumb screw extending to the outside of at least one of the front portion and the rear portion of the end panel, away from the support stand, to attach at least one of the front portion and the rear portion of the end panel to the support stand.

18. The method of claim 17 further comprising:
providing a first clip half;
providing a second clip half; and
drawing the first clip half and the second clip half together around the stand pole with a clip screw.

19. The method of claim 18 further comprising:
providing the first clip half with a glass bushing extending from the first clip half through a hole in at least one of the front portion and the rear portion of the end panel; and
receiving the thumb screw in a threaded socket in the glass bushing to attach at least one of the front portion and the rear portion of the end panel to the support stand.

20. The method of claim 19 further comprising:
providing a second clip having a second glass bushing having a second length selected to extend through both the front portion and the rear portion of the end panel at a point where the front portion and the rear portion overlap;
receiving a second thumb screw in a threaded socket in the second glass bushing to attach both the front panel and the rear panel to the support stand.
